(19) United States
(12) Patent Application Publication
(10) Pub. No.: US 2016/0177025 A1
(43) Pub. Date: Jun. 23, 2016

(54) SHEET PRODUCED FROM CARDS OF PLASTIC MATERIAL

(71) Applicant: Renato Soares DE PAULA, Sao Paulo (BR)

(72) Inventor: Renato Soares DE PAULA, Sao Paulo (BR)

(21) Appl. No.: 14/436,874

(22) PCT Filed: Aug. 18, 2013
(86) PCT No.: PCT/BR2013/000441

§ 371 Date: Mar. 9, 2016

(51) Int. Cl. C08G 63/183; G06K 19/06; C08F 114/06; C08F 236/12; C08F 112/08

(52) U.S. Cl. CPC C08G 63/183; C08F 236/12; C08F 112/08; C08F 114/06; G06K 19/06187

(57) ABSTRACT

A sheet produced from cards of plastic material”, made from plastic material, of various thicknesses and shapes, using waste material of various types of cards, such as identification or magnetic cards, with or without a chip or magnetic strip, made of plastic material such as acrylonitrile butadiene styrene copolymer (ABS), polyethylene terephthalate (PET), polystyrene (PS) or polyvinyl chloride (PVC), all having originated from used cards or industrial waste for producing the sheets.

### CROSS REFERENCE TO RELATED APPLICATION

This application is a national stage entry of PCT/BR2013/0000441 filed Aug. 18, 2013, under the International Convention claiming priority over Brazilian Patent Application No. BR 20 2012 026836-7 filed Oct. 19, 2012.

### FIELD OF THE INVENTION

The present patent application refers to a sheet produced from plastic material, of various thicknesses and shapes, using waste material of various types of cards, such as identification or magnetic cards, with or without a chip or magnetic strip, made of plastic material such as acrylonitrile butadiene styrene copolymer (ABS), polyethylene terephthalate (PET), polystyrene (PS) or polyvinyl chloride (PVC), all originated from used cards or industrial waste for producing said sheets.

### BACKGROUND OF THE INVENTION

Plastic is a synthetic polymeric organic material of macromolecular constitution derived from petroleum and largely used on manufacturing of several products due to its great versatility, its property of adapting into many different shapes, easiness of transformation and resistance, not oxidizable and low operational costs and it is largely used on several industries, commerce, building industry and textile, among others.

However, plastic does not chemically reacts with the majority of other substances and, due to such reason, it does not disintegrate itself, which thus become a major problem to modern society. Due to its very slow biodegradability, one of the major current concerns is the end given to credit, debit, health insurance cards and many others made of plastic material. On majority of the cases, the end given to them is not proper, since these products are only cut by the user and thrown away on common trash and then are thrown away on landfills making environmental problem still worse.

Another problem present when throwing away such material is that these cards have personal and confidential bank data recorded on strips or bands or on chips, and in case of an eventual damage on card, card companies instruct and advise their costumers to brake or cut them with scissors or any other cutting object that can destroy them.

Plastic waste is divided in two distinct groups: post-industrial, i.e., factories throw it away, and after consume, packages and other products that are directly thrown away on consumers' trash.

Majority of products made of plastic can be reused and transformed into new products. This process is known as recycling and in order to overcome problems from improper discard of such material, studies, projects and recycling methods of plastic made materials have been largely developed. In addition to help environment preservation, recycling creates jobs and revenues for millions of people.

### SUMMARY OF THE INVENTION

The object of this utility model patent application presents an innovator process of reusing plastic used on these cards and also has as its main objective find a correct, safe and practical solution regarding the correct use of plastic card waste.

The sheet produced from plastic material card, object of present utility model patent application, can be more comprehended in the light of the attached figure, provided as an example which does not limit the present invention scope.

### BRIEF DESCRIPTION OF THE DRAWINGS

FIG. 1 is a front view of the sheet produced from a plastic card.

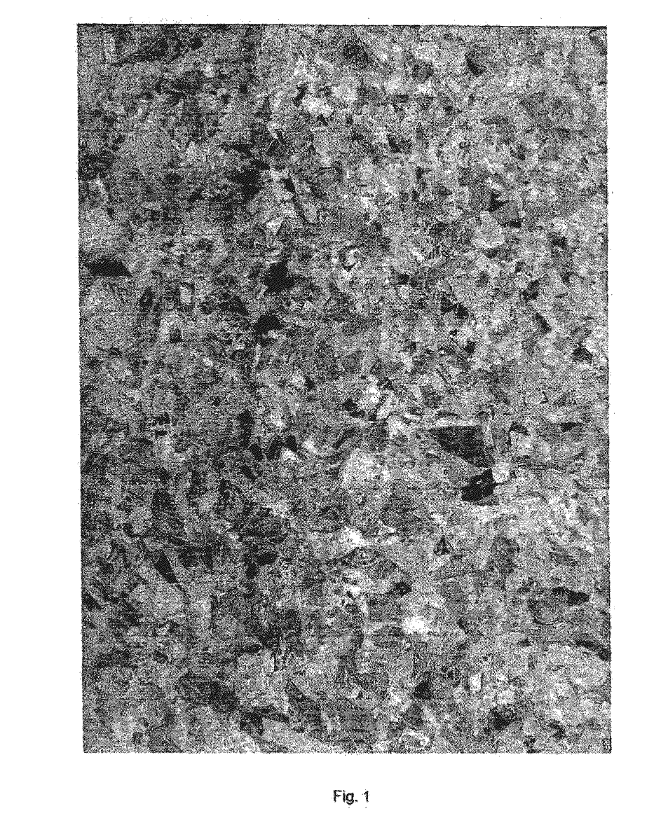

### DETAILED DESCRIPTION OF THE INVENTION

Initially, cards are grind or milled. After this step, grind material is weighed in order to maintain more uniform as possible the characteristics of the batch that will be used for producing the sheet and in accordance to the specific end of the product that will be produced.

This process consists of hot and cold pressing cards waste, grinded in various grain sizes and without being extruded, which thus diminish energy consumption and gases emission.

The grinded material is homogenized, disposed on inox trays or not in order to be pressed with controlled temperature, time and pressure conditions. Afterwards, it is coated with transparent or not PVC films.

After lamination and pressing, the material proceeds to angle recovery finishing and trimming for producing resistant and versatile plastic sheets 10 that can have various thickness and shapes and are made from waste material of magnetic card and can be used on production of many products that can be used on building industry, industry, commerce, handcrafting and other segments.

The sheets 10 are totally colored due to cards mixture and can have many different geometric shapes, drawings, letters and other several shapes and further can have printings of many types and can again be reprocessed from grinding and or milling.

1. A sheet produced from cards of plastic material, wherein the plastic material is obtained from waste of at least one grinded or milled cards and includes an angle recovery and a trimming.

2. The sheet according to claim 1, wherein the sheet is produce having different thickness.

3. (canceled)

4. The sheet according to claim 1, wherein sheet has different shapes.

5. The sheet of claim 1, wherein the grinded or milled cards are selected from the group consisting of identification cards, magnetic cards, magnetic cards with a chip, magnetic card with a magnetic strip.

6. The sheet of claim 1, wherein the plastic material is selected from the group consisting of an acrylonitrile butadiene styrene copolymer (ABS), a polyethylene terephthalate (PET), a polystyrene (PS), and polyvinyl chloride (PVC).
